(19) United States
(12) Patent Application Publication
(10) Pub. No.: US 2024/0417866 A1
(43) Pub. Date: Dec. 19, 2024

(54) SOLID OXIDE CELL

(71) Applicant: SAMSUNG ELECTRO-MECHANICS CO., LTD., Suwon-si (KR)

(72) Inventors: A Reum JUN, Suwon-si (KR); Bon Seok KOO, Suwon-si (KR); Su Beom PARK, Suwon-si (KR); Hyeg Soon AN, Suwon-si (KR); Jeong Suong YANG, Suwon-si (KR)

(73) Assignee: SAMSUNG ELECTRO-MECHANICS CO., LTD., Suwon-si (KR)

(21) Appl. No.: 18/592,304

(22) Filed: Feb. 29, 2024

(30) Foreign Application Priority Data
Jun. 13, 2023 (KR) 10-2023-0075489

(51) Int. Cl. C25B 9/19; H01M 8/12; H01M 8/1213

(52) U.S. Cl. CPC C25B 9/19; H01M 8/1213; H01M 2008/1293

(57) ABSTRACT

A solid oxide cell includes a fuel electrode, an air electrode, and an electrolyte disposed between the fuel electrode and the air electrode. A thickness direction of the electrolyte is a first direction and directions, perpendicular to the first direction and perpendicular to each other, are second and third directions, and the fuel electrode includes a pore array in which a plurality of pores are arranged in the second direction, and each of at least two adjacent pores, among the plurality of pores, has a width that is greater than or equal to a gap between the at least two adjacent pores.

### CROSS-REFERENCE TO RELATED APPLICATIONS

This application claims benefit of priority to Korean Patent Application No. 10-2023-0075489 filed on Jun. 13,2023 in the Korean Intellectual Property Office, the disclosure of which is incorporated herein by reference in its entirety.

### TECHNICAL FIELD

The present disclosure relates to a solid oxide cell.

A solid oxide fuel cell (SOFC) and a solid oxide electrolysis cell (SOEC) include a cell including a fuel electrode, an air electrode, and a solid electrolyte having oxygen ion conductivity, and here, the cell may be referred to as a solid oxide cell. Solid oxide cells produce electrical energy through an electrochemical reaction or produce hydrogen by electrolyzing water through the reverse reaction of a solid oxide fuel cell. Compared to other types of fuel cells or electrolysis cells, such as phosphoric acid fuel cells (PAFC), alkaline fuel cells (AFC), polymer electrolyte membrane fuel cells (PEMFC), and direct methanol fuel cells (DMFC), solid oxide cells are efficient, due to low overvoltage and low irreversible loss based on low activation polarization. In addition, solid oxide cells may be used as a hydrogen and carbon or hydrocarbon-based fuel, widening fuel selection, and may not require expensive precious metals as an electrode catalyst due to a high reaction rate in electrodes.

The solid oxide cells generally have a structure in which an electrolyte is disposed between electrode layers, and a reaction for functioning as a cell occurs in the electrode layers. In order for a reaction to occur effectively in the electrode layers, gas should be able to enter and exit easily, and to this end, technologies of forming the electrode layers as a randomly shaped porous body have been known.

### SUMMARY

An aspect of the present disclosure is to provide a highly reactive solid oxide cell by providing smooth gas flow.

According to an aspect of the present disclosure, a solid oxide cell includes: a fuel electrode; an air electrode; and an electrolyte disposed between the fuel electrode and the air electrode. A thickness direction of the electrolyte is a first direction and directions, perpendicular to the first direction and perpendicular to each other, are second and third directions, and the fuel electrode includes a pore array in which a plurality of pores are arranged in the second direction, and each of at least two adjacent pores, among the plurality of pores, has a width that is greater than or equal to a gap between the at least two adjacent pores.

The width of each of the at least two pores may be a maximum length in the second direction.

The gap between the at least two pores may be a minimum gap in the second direction.

The width of each of the at least two pores may be

two times or more and ten or less times the gap between the at least two pores.

A length of each of at least some of the plurality of pores in the first direction may be greater than a length of each of the at least some of the plurality of pores in the second or third direction.

A length of each of at least some of the plurality of pores in the first direction may be two times or more and twenty or less times a length of each of the at least some of the plurality of pores in the second or third direction.

At least some of the plurality of pores may extend in the first direction from a surface of the fuel electrode.

At least some of the plurality of pores may be spaced apart from the electrolyte in the first direction.

The pore array may be provided in plural.

The plurality of pore arrays may be arranged in the third direction.

The plurality of pore arrays may be arranged in the first and third directions.

A length of each of at least two pores adjacent to each other in the first direction, among the plurality of pores, in the first direction may be greater than a gap between the at least two pores adjacent to each other in the first direction.

At least two of the plurality of pores may have different lengths in the first direction.

According to another aspect of the present disclosure, a solid oxide cell includes: a fuel electrode; an air electrode; and an electrolyte disposed between the fuel electrode and the air electrode. A thickness direction of the electrolyte is a first direction and directions, perpendicular to the first direction and perpendicular to each other, are second and third directions, and the fuel electrode includes a pore array in which a plurality of pores are arranged in the second direction and a line pore disposed to be spaced apart from the pore array in the third direction and having a maximum length in the second direction twice or more a maximum length in the third direction.

The pore array and the line pore may respectively be provided in plural, and the plurality of pore arrays and the plurality of line pores are alternately arranged in the third direction.

According to another aspect of the present disclosure,

a solid oxide cell includes: a fuel electrode; an air electrode; and an electrolyte disposed between the fuel electrode and the air electrode. The fuel electrode includes a first layer of pores and a second layer of pores disposed on the first layer of pores in a thickness direction of the electrolyte, and one pore of the second layer disposed on one pore of the first layer in the thickness direction of the electrolyte are spaced apart from each other.

Another pore of the second layer disposed on another pore of the first layer in the thickness direction of the electrolyte may be connected to each other.

Two adjacent pores, among the pores of the first

layer, each may have a width greater than or equal to a gap between the two adjacent pores among the pores of the first layer.

Two adjacent pores, among the pores of the second layer, each may have a width greater than or equal to a gap between the two adjacent pores among the pores of the second layer.

The fuel electrode may include a porous body having randomly distributed pores, and the first layer of pores and the second layer of pores may be disposed in the porous body.

The one pore of the first layer and the one pore of the second layer disposed on the one pore of the first layer in the thickness direction of the electrolyte each may have a width greater than a width of one of the randomly distributed pores.

In a plane perpendicular to the thickness direction of the electrolyte, the pores of the first layer may be in a form of an array and the pores of the second layer may be in a form of an array.

### BRIEF DESCRIPTION OF DRAWINGS

The above and other aspects, features, and advantages of the present disclosure will be more clearly understood from the detailed following description, taken in conjunction with the accompanying drawings, in which:

FIG. 1 is a perspective view schematically illustrating a solid oxide cell according to an exemplary embodiment in the present disclosure;

FIG. 2 is a cross-sectional view taken along line I-I′ of FIG. 1, schematically illustrating a region of a solid oxide cell;

FIG. 3 is a cross-sectional view taken along line II-II′ of FIG. 1, schematically illustrating a region of a solid oxide cell;

FIG. 4 is a cross-sectional view taken along line II-II′ of FIG. 1, schematically illustrating a region of a solid oxide cell;

FIG. 5 is an enlarged view of a region R1 of a fuel electrode shown in FIG. 2;

FIG. 6 is an enlarged view of a region R2 of an electrolyte shown in FIG. 2;

FIG. 7 is an enlarged view of a region R3 of an air electrode shown in FIG. 2;

FIG. 8 schematically illustrates some of the processes of a method of manufacturing a solid oxide cell;

FIG. 9 is a cross-sectional view schematically illustrating a region of a solid oxide cell according to a modified example;

FIG. 10 is a cross-sectional view schematically illustrating a region of a solid oxide cell according to a modified example; and

FIG. 11 is a cross-sectional view schematically illustrating a region of a solid oxide cell according to a modified example.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

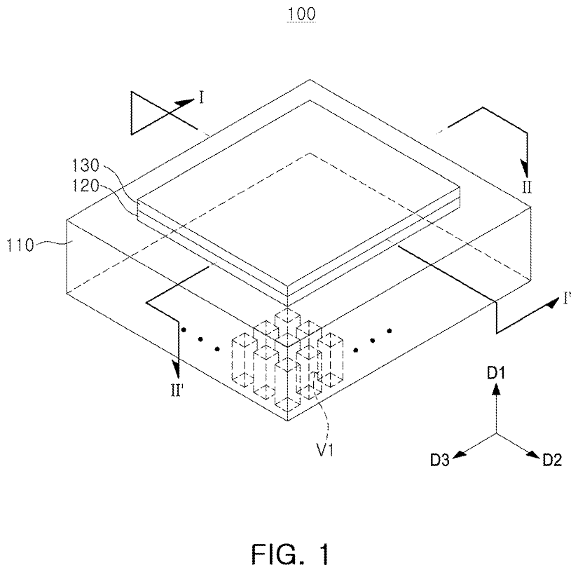

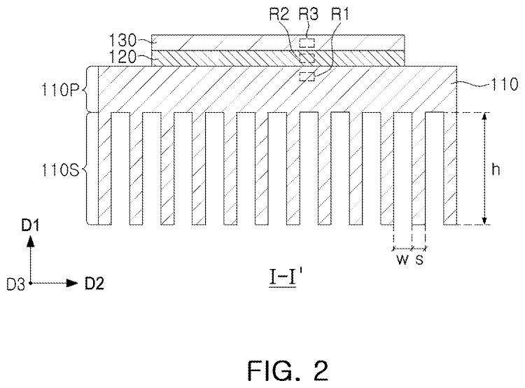

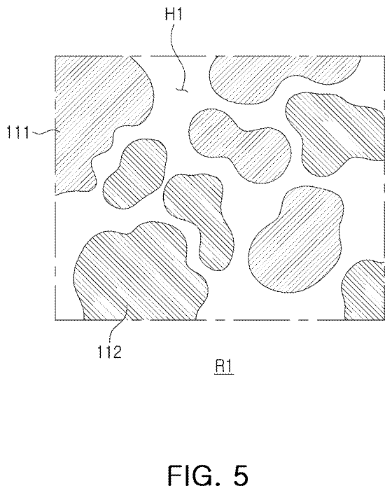

FIG. 1 is a perspective view schematically illustrating a solid oxide cell according to an exemplary embodiment in the present disclosure. FIGS. 2 to 4 are cross-sectional views schematically illustrating a region of a solid oxide cell. FIGS. 5 to 7 are enlarged views of regions of a fuel electrode, an electrolyte, and an air electrode, respectively.

First, referring to FIGS. 1 to 3, a solid oxide cell 100 according to an exemplary embodiment in the present disclosure includes a fuel electrode 110, an air electrode 130, and an electrolyte 120 disposed therebetween, as main components. Here, the fuel electrode 110 includes a pore array A1 in which a plurality of pores V1 are arranged in one direction D2, perpendicular to a first direction D1, which is a thickness direction of the electrolyte 120, and among the plurality of pores V1, at least two pores adjacent to each other have a width w that is wider than or equal to a gap s therebetween. The pores V1 arranged in one direction D2 within the fuel electrode 110 may function as a passage through which gas may enter and exit, and accordingly, reactivity within the solid oxide cell 100 may be improved. In addition, reactivity may be further improved by adjusting the width w of the pore V1 to be wider than or equal to the gap s between the pores VI to ensure a sufficient size of the pore V1. Therefore, the pore V1 structure may promote lateral gas flow within the fuel electrode 110 and, in particular, when the solid oxide cell 100 is used as a solid oxide electrolysis cell (SOEC), the pore VI structure may facilitate the flow of water vapor, thereby contributing to improving characteristics.

Hereinafter, the components of the solid oxide cell 100 will be described in detail. The solid oxide cell 100 may be used as either a fuel cell or a water electrolysis cell. In a water electrolysis cell mode, the fuel electrode 110 and the air electrode 130 of the solid oxide cell 100 may undergo a reaction opposite to that in the fuel cell. Specifically, if the solid oxide cell 100 is a fuel cell, for example, water production or an oxidation reaction of a carbon compound may occur due to oxidation of hydrogen in the fuel electrode 110, and an oxygen ion generating reaction may occur due to decomposition of oxygen in the air electrode 130. If the solid oxide cell 100 is a water electrolysis cell, the opposite reaction may occur. For example, hydrogen gas may be generated in the fuel electrode 110 due to a reduction reaction of water, and oxygen may be generated in the air electrode 130. Also, as another example, in the case of a fuel cell, hydrogen may be decomposed (generating hydrogen ions) in the fuel electrode 110, and water may be generated as oxygen and hydrogen ions are bonded in the air electrode 130. In the case of a water electrolysis cell, a reaction of water decomposition (generating hydrogen and oxygen ions) may occur in the fuel electrode 110, and oxygen may be generated in the air electrode 130. Also, ions may migrate from the electrolyte 120 to the fuel electrode 110 or the air electrode 130.

To describe in detail the materials constituting the fuel electrode 110, the electrolyte 120, and the air electrode 130, first, as illustrated in FIG. 5, the fuel electrode 110 may include an electronic conductor 111 and an ion conductor 112, and these may be sintered bodies of particles. The electronic conductor 111 may perform an electrical conduction function and a catalytic function, and may include, for example, a Ni-based, Co-based, or Cu-based metal, or a lanthanum chromite-based (La₁₋ₓSrₓCrO₃, where 0≤x<1) material. Also, the ion conductor 111 may include one or more of yttria-stabilized zirconia-based (YSZ), ceria-based (CeO2), bismuth oxide-based (Bi2O3), and lanthanum gallate-based (LaGaO3) materials. In addition, the fuel electrode 110 may be a porous body including random pores H1, random in shape and arrangement, and here, the random pores H1 are distinguished from the regularly arranged pores V1. In the present exemplary embodiment, the flow of gas within the fuel electrode 110 may be further improved and effectively controlled through the regularly arranged pores V1. That is, the random pores H1 may be formed by adding a polymer-based pore former when manufacturing the fuel electrode 110 and then removing the same by heat treatment, and the random pores H1 tend to have high tortuosity and a small diameter. When only the random pores H1 are used, it may be difficult for gas having a low average moving distance and intrinsic diffusion coefficient, such as water vapor, to flow smoothly, and in particular, it may be difficult to obtain a smooth gas flow in the lateral direction (the direction, perpendicular to D1), and this problem may be reduced using the pore array Al. Meanwhile, a region of the fuel electrode 110 adjacent to the electrolyte 120 may be referred to as a fuel electrode functional layer 110P, and the other region excluding the fuel electrode functional layer 110P may be referred to as a fuel electrode support layer 110S. In this case, the pores V1 may not be formed in the fuel electrode functional layer 110P, or if ever, they may exist only in a very small region. The fuel electrode functional layer 110P and the fuel electrode support layer 110S may be formed of the same material or may be formed of different materials.

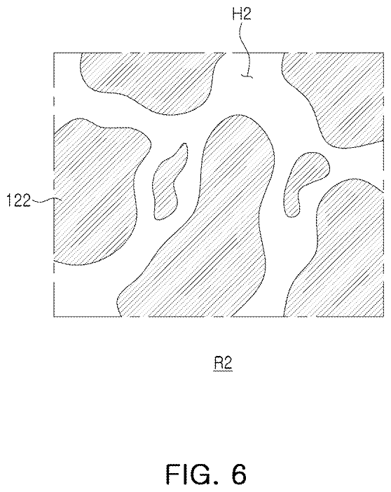

Referring to FIG. 6, the electrolyte 120 may be a sintered body of particles. The electrolyte 120 may be a porous body including random pores H2 through which gas, fluids, etc. may enter and exit. The electrolyte 120 may include an ion conductor 122, and here, an example of a material constituting the ion conductor 122 may include stabilized zirconia. Specifically, the ion conductor 122 may include one or more of scandia stabilized zirconia (SSZ), yttria stabilized zirconia (YSZ), scandia ceria stabilized zirconia (SCSZ), scandia ceria yttria stabilized zirconia (SCYSZ), and scandia ceria ytterbia stabilized zirconia (SCYbSZ).

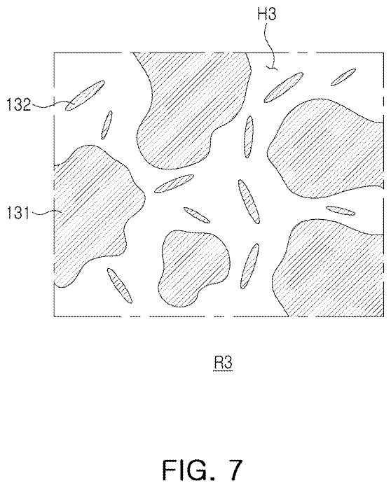

Referring to FIG. 7, the air electrode 130 may include an electronic conductor 131 and an ion conductor 132, which may be sintered bodies of particles. In the air electrode 130, the electronic conductor 131 may include an electrically conductive material, such as an electrically conductive perovskite material, such as lanthanum strontium manganite (LSM). Other conductive perovskites, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or metal such as Pt may also be used. The ion conductor 132 may include materials, such as yttria-stabilized zirconia-based (YSZ), ceria-based (CeO₂), bismuth oxide-based (Bi2O3), and lanthanum gallate-based (LaGaO3). The air electrode 130 may include about 10 wt % to about 90wt % of the electronic conductor 131 and about 10 wt % to about 90 wt % of the ion conductor 132. However, depending on the exemplary embodiment, the air electrode 130 may not include the ion conductor 132. As shown, the air electrode 130 may be a porous body including random pores H3, through which gas, fluid, etc. may enter and exit.

Meanwhile, the solid oxide cell 100 according to the present exemplary embodiment may have a fuel electrode-supported structure in which the electrolyte 120 and the air electrode 130 are supported by the fuel electrode 110. In the case of the fuel electrode-supported solid oxide cell 100, a thickness of the electrolyte 120 is relatively thin, so resistance to ion migration may be reduced and power density may be improved, while the fuel electrode 110 is formed relatively thick, so a moving distance of the gas may increase. The increase in the moving distance of the gas in the fuel electrode 110 may degrade uniformity of supply of a reaction gas, especially when functioning as a water electrolysis cell, to vary the extent to which an electrochemical reaction occurs locally, which may cause structural deterioration of the solid oxide cell 100. As in the present exemplary embodiment, by employing the pores V1 arranged in the second direction D2 within the fuel electrode 110 and having the width w wider than or equal to the gap s, a degradation of performance due to the increase in the moving distance of gas in the fuel electrode-supported solid oxide cell 100 may be reduced. However, the solid oxide cell 100 according to the present exemplary embodiment need not be used only as the fuel electrode-supported structure, and an electrolyte 120 supported structure in which the fuel electrode 110 and the air electrode 130 are supported by the electrolyte 120 may also be used.

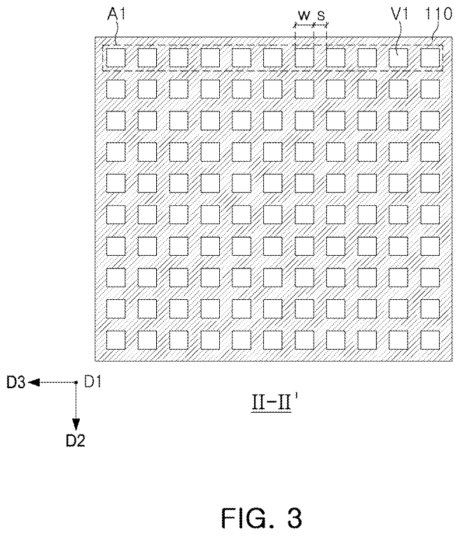

The structure of the pores V1 of the fuel electrode 110 will be described in more detail with reference to FIGS. 2 and 3. As described above, the fuel electrode 110 may include the pore array A1 in which the plurality of pores V1 are arranged in the second direction D2, and at least two pores V1 adjacent to each other among the plurality of pores V1 have a width w that is wider than or equal to the gap s therebetween. Here, the first direction D1 refers to a thickness direction of the electrolyte 120, and the second direction D2 and a third direction D3 refer to directions, perpendicular to the first direction D1, and perpendicular to each other. As such, in the present exemplary embodiment, the plurality of pores V1 are arranged in the lateral direction (corresponding to D2) of the fuel electrode 110 and have the relatively wide width w to facilitate the flow of gas. Meanwhile, in FIGS. 2 and 3, all pores VI satisfy the aforementioned width and gap conditions (w≥s), but it is also possible that only some of the pores VI satisfy these conditions.

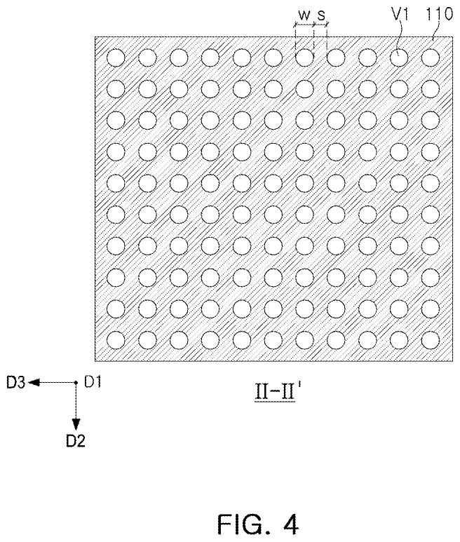

The width w of the pores V1 may be defined as the maximum length in the second direction D2, and the gap s between the pores V1 may be defined as the minimum gap in the second direction D2. As in the present exemplary embodiment, when a D2-D3 cross-section of the pore V1 is rectangular or has a similar shape, the length of the pore V1 in the second direction D2 or the gap between the pores V1 in the second direction D2 may be substantially constant. However, when the D2-D3 cross-section of the pore V1 is not rectangular, for example, when the width w of the pore V1 changes as in a case in which the D2-D3 cross-section is circular as in the modified example of FIG. 4, the width w of the pore V1 may be defined as the maximum length in the second direction D2 and the gap s between the pores V1 may be defined as the minimum gap in the second direction D2.

In the case of the present exemplary embodiment, the width w of at least two pores V1 may be twice or more the gap between at least two pores V1 to sufficiently secure the volume of the pores V1. If the size of the pores V1 is excessively large, the structural stability of the fuel electrode 110 may be impaired, and thus, the width w of at least two pores V1 may be 10 times or less the gap between at least two pores V1, more specifically, 5 times or less. In addition, as shown, at least some of the pores V1, among the plurality of pores V1, may have a length h in the first direction D1 corresponding to the height longer than the length in the second direction D2 and the third direction D3. In this case, in order to sufficiently secure the volume of the pores V1, at least some of the pores V1 among the plurality of pores V1 may have a length h in the first direction D1 twice or more the length in the second direction D2 and the third direction D3 and may be 20 times or less in terms of securing the structural stability of the fuel electrode 110.

As shown, at least some of the pores V1 among the plurality of pores V1 may extend in the first direction D1 to be exposed to a surface (a lower surface in the drawing) of the fuel electrode 110 to facilitate gas exchange with the outside. In addition, at least some of the pores V1 among the plurality of pores V1 may be spaced apart from the electrolyte 120 in the first direction D1. In this case, as described above, a region of the fuel electrode 110 adjacent to the electrolyte 120 is employed as the fuel electrode functional layer 110P, while the other region excluding the fuel electrode functional layer 110P may be employed as the fuel electrode support layer 110S. In this case, pores V1 may not be formed in the fuel electrode functional layer 110P, or if ever, they may exist in only a small portion of the fuel electrode functional layer 110P.

Meanwhile, in the present exemplary embodiment, a plurality of pore arrays A1 may be provided, and in this case, the plurality of pore arrays A1 may be arranged in the third direction D3. As a result, the plurality of pores V1 may be arranged in a regular lattice structure.

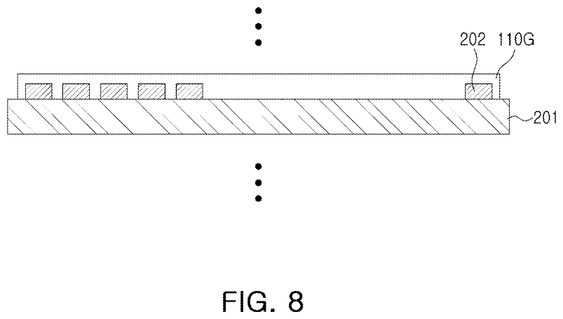

The pores V1 of the fuel electrode 110 may be formed in various manners, and an example will be described with reference to FIG. 8. The fuel electrode 110 may be implemented by stacking a plurality of ceramic green sheets and then sintering the same. In this process, the pores V1 may be formed in the fuel electrode 110. Specifically, a pattern portion 202 and a green sheet 110G may be formed on a carrier film 201, and the green sheet 110G may be formed to cover side and upper surfaces of the pattern portion 202 as shown. The pattern portion 202 may be formed of a material that may be removed during a sintering process, for example, polymer beads. In the case of the carrier film 201, a film known in the art, such as PET film, may be used. A plurality of these green sheets 110G are stacked to form a stack, and the carrier film 201 may be separated from the green sheet 110G before stacking. The stack may be sintered to form the fuel electrode 110 in the form of a sintered body, and the pattern portion 202 may be removed during the sintering process, thereby forming the pores VI in the fuel electrode 110.

As in the process example of FIG. 8, when the pattern portion 202 is formed in each green sheet 110G and the pores V1 of the fuel electrode 110 are realized by stacking the green sheets 110G, the plurality of pores V1 may also be implemented to be arranged in the first direction DI as the fuel electrode 110 material remains between the pores V1 in the first direction D1. This corresponds to a structure in which a plurality of pore arrays A1 are arranged in the first direction D1 and the third direction D3, as illustrated in

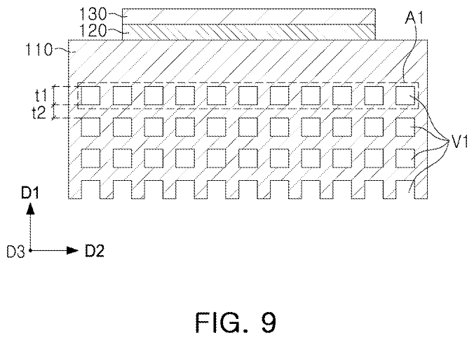

FIG. 9. In this case, a length t1 of each of at least two pores V1 adjacent to each other in the first direction D1, among the plurality of pores V1, in the first direction D1 may be longer than a gap t2 therebetween in the first direction (t1>t2), and according to this configuration, the volume of the pores V1 may be sufficiently secured even when the fuel electrode 110 material remains between the pores V1 in the first direction D1. In addition, in the case of using the process example of FIG. 8, the pores V1 may be formed in the fuel electrode 110 more effectively, compared to a case of using a physical processing method, such as laser processing.

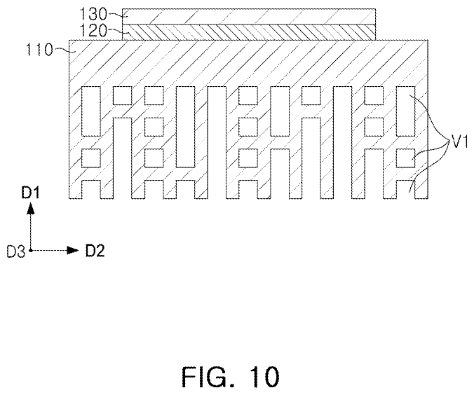

Unlike the configuration illustrated in FIG. 9, some of the pores VI may be merged in the first direction D1, and in this case, the fuel electrode 110 material may not remain between the pores V1. Accordingly, as illustrated in FIG. 10, at least two pores V1, among the plurality of pores V1, may have different lengths in the first direction D1. If all pores V1 are merged in the first direction D1, such pores V1 as in the exemplary embodiment of FIG. 2 may be obtained.

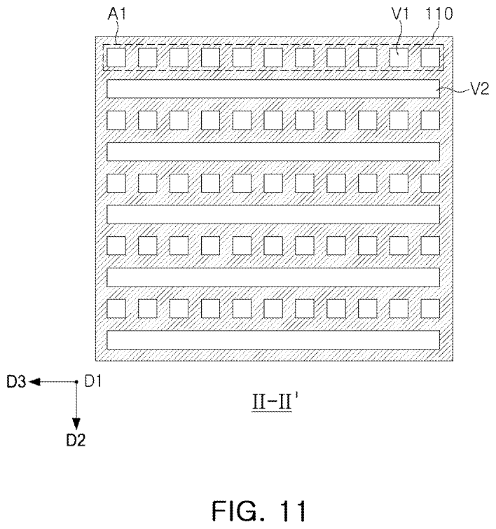

Referring to FIG. 11, a pore shape that may be employed in a solid oxide cell according to another modified example will be described. In the exemplary embodiment of FIG. 11, the fuel electrode 110 includes different types of pores V1 and V2. Specifically, the fuel electrode 110 includes a pore array A1 in which a plurality of pores V1 are arranged in the second direction D2 and a line pore V2 spaced apart from the pore array A1 in the third direction D3 and having the maximum length in the direction D2 twice as long as the maximum length in the third direction D3.

In the case of including both the pore array A1 and the line pore V2 as illustrated in FIG. 11, a width and gap conditions (was) of the pores VI described above may not necessarily need to be satisfied. As shown, a plurality of pore arrays Al and a plurality of line pores V2 may be provided, and the plurality of pore arrays A1 and the plurality of line pores V2 may be alternately arranged in one direction, for example, in the third direction D3. In addition to the pores VI arranged in one direction, the line pores V2 may be used as an auxiliary passage to allow gas flow to occur more rapidly, and when these different types of pores V1 and V2 are used, responsiveness may be further improved.

In the case of the solid oxide cell according to an example of the present disclosure, reactivity within the cell may be excellent by ensuring a smooth flow of gas. Therefore, performance may be improved when the solid oxide cell is used as a fuel cell or a water electrolysis cell.

While example exemplary embodiments have been shown and described above, it will be apparent to those skilled in the art that modifications and variations could be made without departing from the scope of the present disclosure as defined by the appended claims.

What is claimed is:

1. A solid oxide cell comprising:
a fuel electrode;
an air electrode; and
an electrolyte disposed between the fuel electrode and the air electrode,
wherein a thickness direction of the electrolyte is a first direction and directions, perpendicular to the first direction and perpendicular to each other, are second and third directions, and the fuel electrode includes a pore array in which a plurality of pores are arranged in the second direction, and each of at least two adjacent pores, among the plurality of pores, has a width that is greater than or equal to a gap between the at least two adjacent pores.

2. The solid oxide cell of claim 1, wherein the width of each of the at least two pores is a maximum length in the second direction.

3. The solid oxide cell of claim 1, wherein the gap between the at least two pores is a minimum gap in the second direction.

4. The solid oxide cell of claim 1, wherein the width of each of the at least two pores is two times or more and ten or less times the gap between the at least two pores.

5. The solid oxide cell of claim 1, wherein a length of each of at least some of the plurality of pores in the first direction is greater than a length of each of the at least some of the plurality of pores in the second or third direction.

6. The solid oxide cell of claim 1, wherein a length of each of at least some of the plurality of pores in the first direction is two times or more and twenty or less times a length of each of the at least some of the plurality of pores in the second or third direction.

7. The solid oxide cell of claim 1, wherein at least some of the plurality of pores extend in the first direction from a surface of the fuel electrode.

8. The solid oxide cell of claim 1, wherein at least some of the plurality of pores are spaced apart from the electrolyte in the first direction.

9. The solid oxide cell of claim 1, wherein the pore array is provided in plural.

10. The solid oxide cell of claim 9, wherein the plurality of pore arrays are arranged in the third direction.

11. The solid oxide cell of claim 9, wherein the plurality of pore arrays are arranged in the first and third directions.

12. The solid oxide cell of claim 11, wherein a length of each of at least two pores adjacent to each other in the first direction, among the plurality of pores, in the first direction is greater than a gap between the at least two pores adjacent to each other in the first direction.

13. The solid oxide cell of claim 11, wherein at least two of the plurality of pores have different lengths in the first direction.

14. A solid oxide cell comprising:
a fuel electrode;
an air electrode; and
an electrolyte disposed between the fuel electrode and the air electrode,
wherein a thickness direction of the electrolyte is a first direction and directions, perpendicular to the first direction and perpendicular to each other, are second and third directions, and the fuel electrode includes a pore array in which a plurality of pores are arranged in the second direction and a line pore disposed to be spaced apart from the pore array in the third direction and having a maximum length in the second direction twice or more a maximum length in the third direction.

15. The solid oxide cell of claim 14, wherein the pore array and the line pore are each provided in plural, and the plurality of pore arrays and the plurality of line pores are alternately arranged in the third direction.

16. A solid oxide cell comprising:
a fuel electrode;
an air electrode; and
an electrolyte disposed between the fuel electrode and the air electrode,
wherein the fuel electrode includes a first layer of pores and a second layer of pores disposed on the first layer of pores in a thickness direction of the electrolyte, and
one pore of the second layer disposed on one pore of the first layer in the thickness direction of the electrolyte are spaced apart from each other.

17. The solid oxide cell of claim 16, wherein another pore of the second layer disposed on another pore of the first layer in the thickness direction of the electrolyte are connected to each other.

18. The solid oxide cell of claim 16, wherein two adjacent pores, among the pores of the first layer, each have a width greater than or equal to a gap between the two adjacent pores among the pores of the first layer.

19. The solid oxide cell of claim 16, wherein two adjacent pores, among the pores of the second layer, each have a width greater than or equal to a gap between the two adjacent pores among the pores of the second layer.

20. The solid oxide cell of claim 16, wherein the fuel electrode includes a porous body having randomly distributed pores, and
the first layer of pores and the second layer of pores are disposed in the porous body.

21. The solid oxide cell of claim 20, wherein the one pore of the first layer and the one pore of the second layer disposed on the one pore of the first layer in the thickness direction of the electrolyte each have a width greater than a width of one of the randomly distributed pores.

22. The solid oxide cell of claim 16, wherein in a plane perpendicular to the thickness direction of the electrolyte, the pores of the first layer are in a form of an array and the pores of the second layer are in a form of an array.
